(19) United States
(12) Patent Application Publication
(10) Pub. No.: US 2015/0022069 A1
(43) Pub. Date: Jan. 22, 2015

(54) STORAGE DEVICE CARRIER

(71) Applicant: COOLER MASTER DEVELOPMENT CORPORATION, NEW TAIPEI CITY (TW)

(72) Inventor: Yuqing Lv, New Taipei City (TW)

(21) Appl. No.: 13/947,112

(22) Filed: Jul. 22, 2013

(51) Int. Cl. G06F 1/18

(52) U.S. Cl. CPC G06F 1/187
USPC 312/309

(57) ABSTRACT

A storage device carrier includes a first frame, a first support member, a second frame and a second support member. The first frame includes a first base plate and a first side plate. The first side plate is extended from the first base plate. The first support member is pivotally connected to the first side plate. The second frame includes a second base plate and a second side plate. The second side plate is extended from the second base plate. The first base plate is slidably connected to the second base plate. The second support member is pivotally connected to the second side plate. The first support member and the second support member are opposite to each other.

### BACKGROUND OF THE INVENTION

1. Field of the Invention

The invention relates to a storage device carrier and, more particularly, to a storage device carrier capable of carrying different storage devices with different sizes.

2. Description of the Prior Art

As technology advances and develops, a computer is considered a necessity by a lot of people in daily life. In general, the computer is usually equipped with a storage device, such as a 3.5″ hard disk drive (HDD) or a 2.5″ solid state drive (SSD), for storing necessary programs and data. So far the storage device is always installed in the computer by a carrier, wherein the storage device is pressed into the carrier and fixed by some specific fixing components. However, the conventional carrier is a single-piece structure, so it can be used to carry a storage device with a specific size only. Once a user wants to replace the original storage device with a new one with another size, he/she has to replace the carrier simultaneously so that the use cost will increase.

### SUMMARY OF THE INVENTION

The invention provides a storage device carrier capable of carrying different storage devices with different sizes, so as to solve the aforesaid problems.

According to an embodiment of the invention, a storage device carrier comprises a first frame, a first support member, a second frame and a second support member. The first frame comprises a first base plate and a first side plate. The first side plate is extended from the first base plate. The first support member is pivotally connected to the first side plate. The second frame comprises a second base plate and a second side plate. The second side plate is extended from the second base plate. The first base plate is slidably connected to the second base plate. The second support member is pivotally connected to the second side plate. The first support member and the second support member are opposite to each other. The first base plate and the second base plate are capable of sliding with respect to each other, so as to space the first side plate and the second side plate with a first distance or a second distance. When the first side plate and the second side plate are spaced with the first distance, and the first support member and the second support member are expanded with respect to the first side plate and the second side plate, respectively, a first storage device is capable of being carried on the first support member and the second support member and sandwiched in between the first side plate and the second side plate. When the first side plate and the second side plate are spaced with the second distance, and the first support member and the second support member are folded with respect to the first side plate and the second side plate, respectively, a second storage device is capable of being carried on the first base plate and the second base plate and sandwiched in between the first side plate and the second side plate.

As mentioned in the above, a user can operate the first base plate and the second base plate to slide with respect to each other, so as to adjust the distance between the first side plate and the second side plate. Furthermore, the user can rotate the first support member and the second support member, so as to expand or fold the first support member and the second support member with respect to the first side plate and the second side plate. Accordingly, the storage device carrier of the invention can be used to carry different storage devices with different sizes. In other words, the invention utilizes a single storage device carrier to carry different storage devices with different sizes. The operation of the invention is convenient and the use cost can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded view illustrating a storage device carrier according to a first embodiment of the invention.

FIG. 2 is an exploded view illustrating the storage device carrier shown in FIG. 1 in another viewing angle.

FIG. 3 is an assembly view illustrating the storage device carrier shown in FIG. 1, wherein the first side plate and the second side plate are spaced with a first distance.

FIG. 4 is an assembly view illustrating the storage device carrier shown in FIG. 3 in another viewing angle.

FIG. 5 is an assembly view illustrating the storage device carrier shown in FIG. 1, wherein the first side plate and the second side plate are spaced with a second distance.

FIG. 6 is an assembly view illustrating the storage device carrier shown in FIG. 5 in another viewing angle.

FIG. 7 is an assembly view illustrating the storage device carrier shown in FIG. 1, wherein the first side plate and the second side plate are spaced with a third distance.

FIG. 8 is an assembly view illustrating the storage device carrier shown in FIG. 7 in another viewing angle.

FIG. 9 is a schematic view illustrating a first storage device carried by the storage device carrier 1 shown in FIG. 3.

FIG. 10 is a schematic view illustrating a second storage device carried by the storage device carrier shown in FIG. 7.

FIG. 11 is a schematic view illustrating the second storage device carried by the storage device carrier shown in FIG. 5.

FIG. 12 is an assembly view illustrating a storage device carrier according to a second embodiment of the invention.

### DETAILED DESCRIPTION

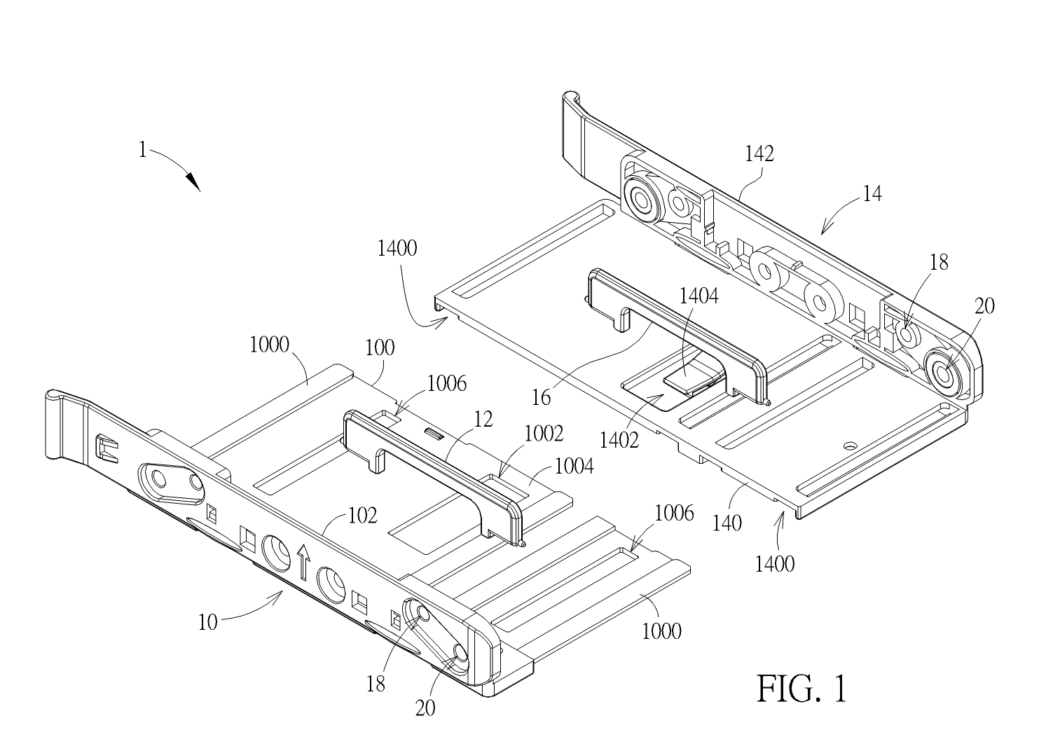

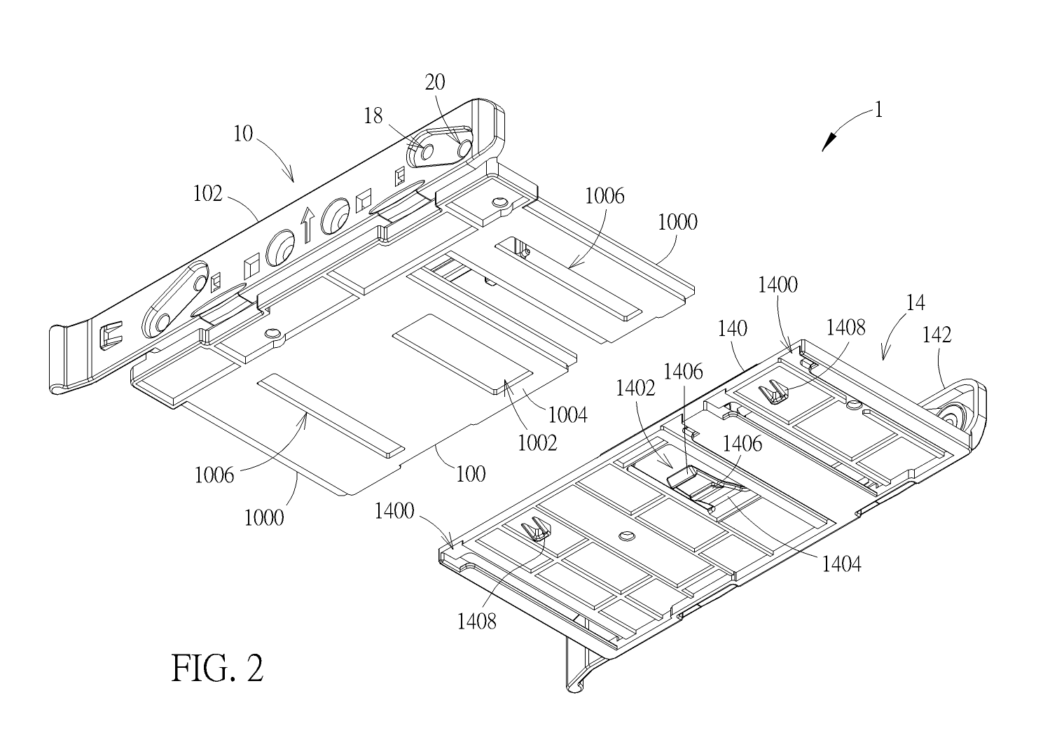

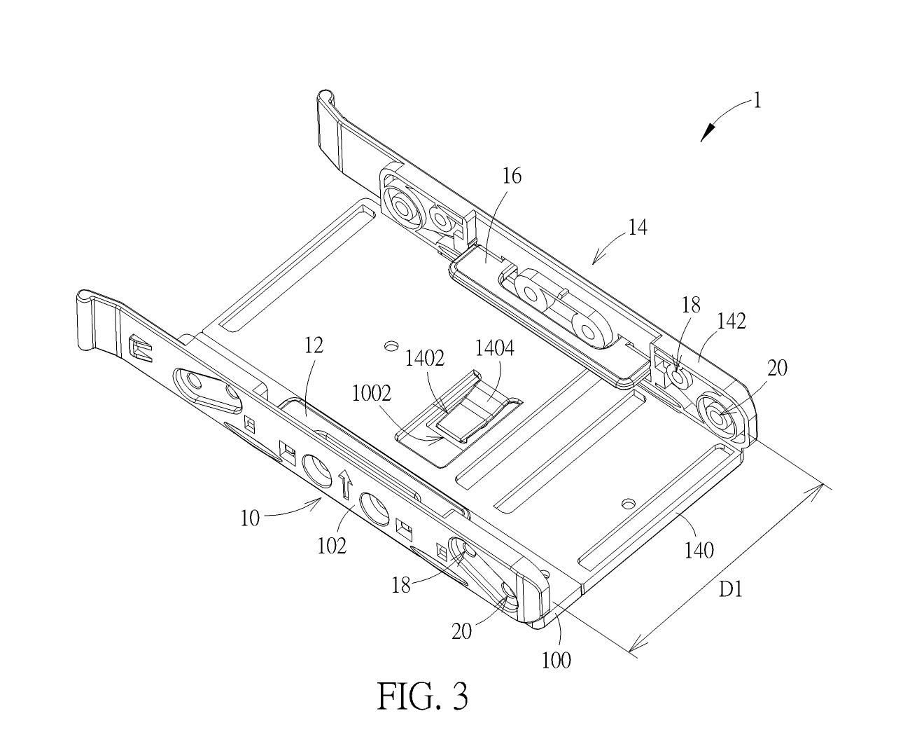

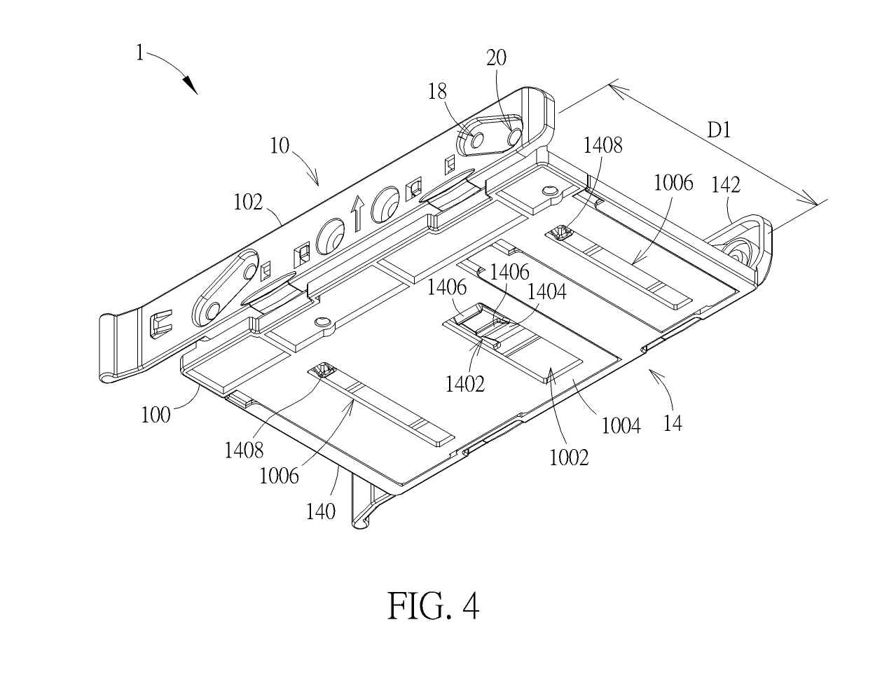

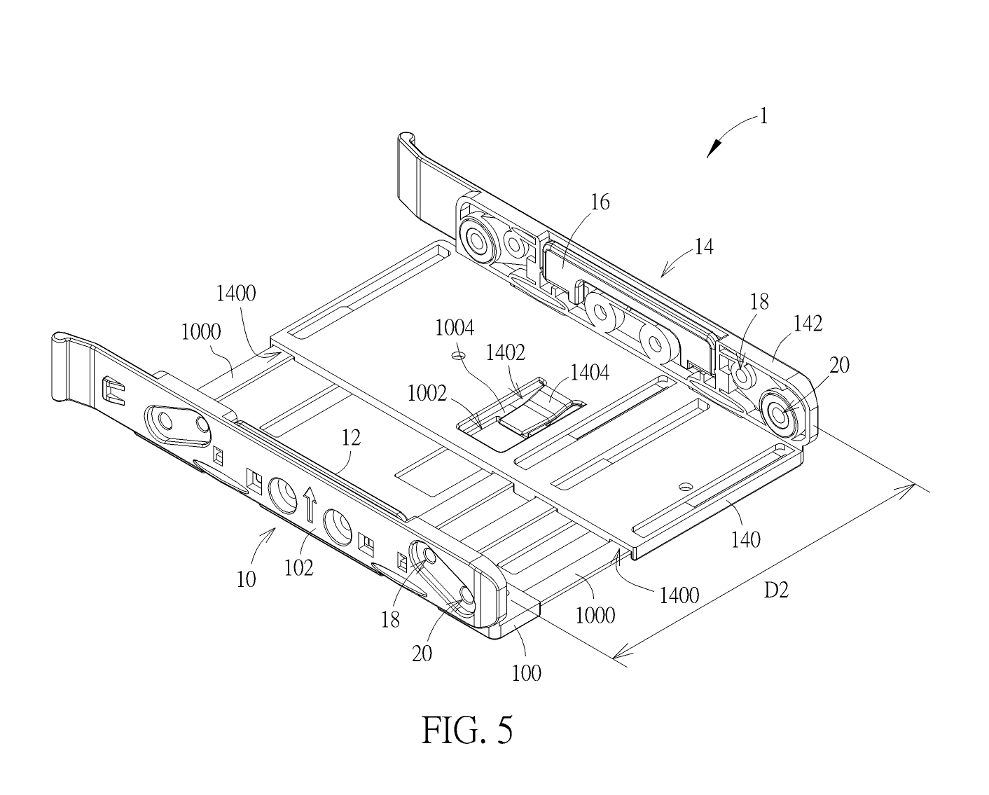

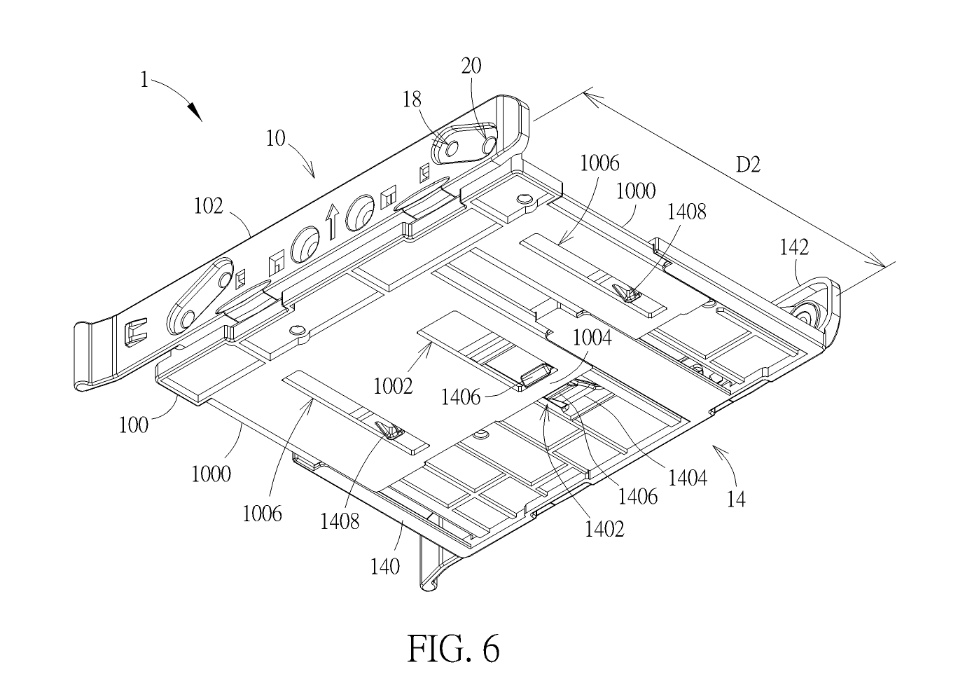

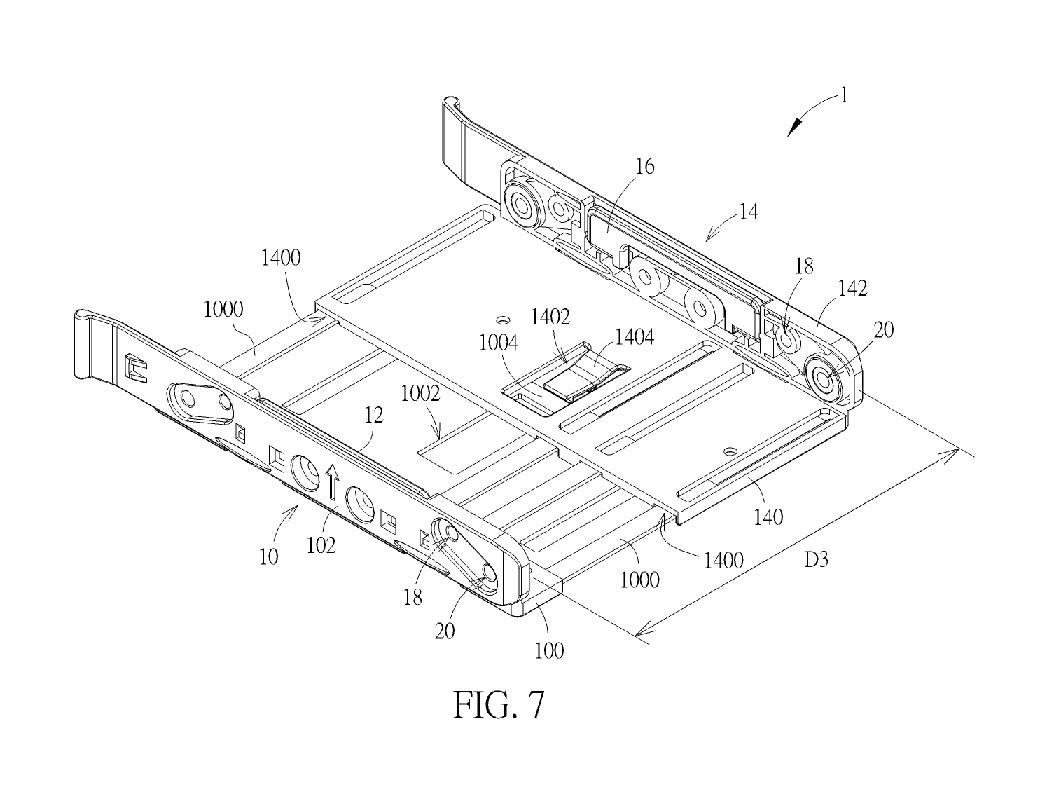

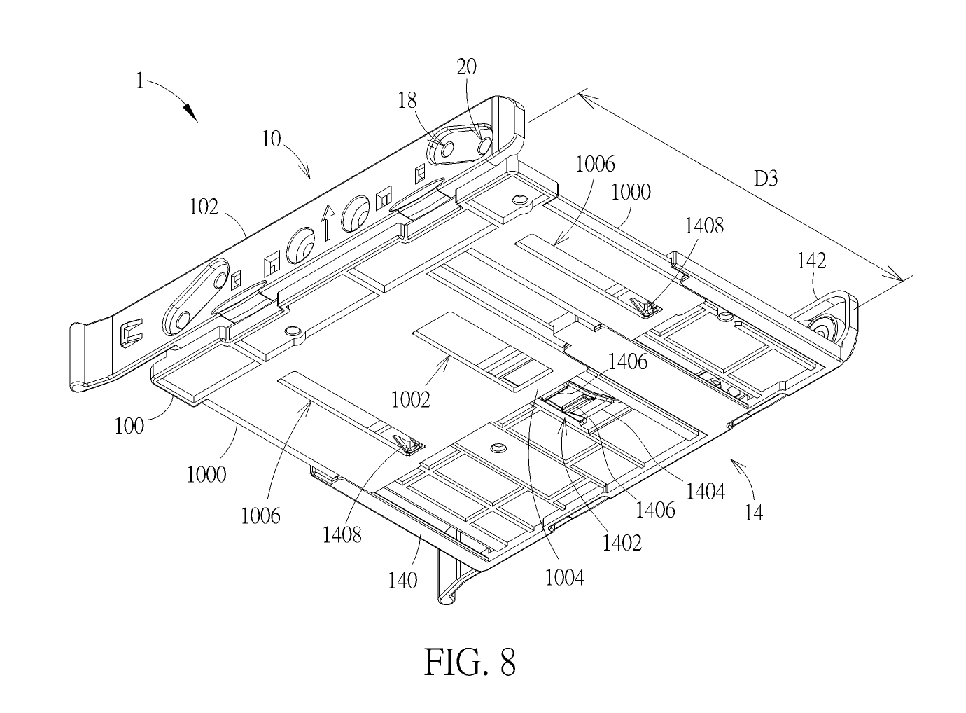

Referring to FIGS. 1 to 8, FIG. 1 is an exploded view illustrating a storage device carrier 1 according to a first embodiment of the invention; FIG. 2 is an exploded view illustrating the storage device carrier 1 shown in FIG. 1 in another viewing angle; FIG. 3 is an assembly view illustrating the storage device carrier 1 shown in FIG. 1, wherein the first side plate 102 and the second side plate 142 are spaced with a first distance D1; FIG. 4 is an assembly view illustrating the storage device carrier 1 shown in FIG. 3 in another viewing angle; FIG. 5 is an assembly view illustrating the storage device carrier 1 shown in FIG. 1, wherein the first side plate 102 and the second side plate 142 are spaced with a second distance D2; FIG. 6 is an assembly view illustrating the storage device carrier 1 shown in FIG. 5 in another viewing angle; FIG. 7 is an assembly view illustrating the storage device carrier 1 shown in FIG. 1, wherein the first side plate 102 and the second side plate 142 are spaced with a third distance D3; and FIG. 8 is an assembly view illustrating the storage device carrier 1 shown in FIG. 7 in another viewing angle.

As shown in FIGS. 1 and 2, the storage device carrier 1 comprises a first frame 10, a first support member 12, a second frame 14 and a second support member 16. The first frame 10 comprises a first base plate 100 and a first side plate 102. The first side plate 102 is extended from the first base plate 100, such that the first base plate 100 and the first side plate 102 are substantially L-shaped. The second frame 14 comprises a second base plate 140 and a second side plate 142. The second side plate 142 is extended from the second base plate 140, such that the second base plate 140 and the second side plate 142 are substantially L-shaped.

In this embodiment, the first base plate 100 has a plurality of sliding portions 1000 and the second base plate 140 has a plurality of sliding grooves 1400. After the first frame 10 and the second frame 14 are assembled with each other, the sliding portions 1000 are disposed in the sliding grooves 1400, such that the first base plate 100 is slidably connected to the second base plate 140. Accordingly, the first base plate 100 and the second base plate 140 are capable of sliding with respect to each other, so as to space the first side plate 102 and the second side plate 142 with a first distance D1 (as shown in FIGS. 3 and 4), a second distance D2 (as shown in FIGS. 5 and 6) or a third distance D3 (as shown in FIGS. 7 and 8). In this embodiment, the third distance D3 is larger than the second distance D2, and the second distance D2 is larger than the first distance D1. Furthermore, the first support member 12 is pivotally connected to the first side plate 102 and the second support member 16 is pivotally connected to the second side plate 142, wherein the first support member 12 and the second support member 16 are opposite to each other. Accordingly, the first support member 12 and the second support member 16 are capable of rotating with respect to the first side plate 102 and the second side plate 142, respectively, so as to be expanded (as shown in FIG. 3) or folded (as shown in FIGS. 5 and 7) with respect to the first side plate 102 and the second side plate 142.

In this embodiment, the first base plate 100 has an engaging groove 1002 and the second base plate 140 has an engaging structure 1402. When the first base plate 100 and the second base plate 140 slide with respect to each other, the engaging structure 1402 is selectively engaged with or disengaged from an edge 1004 of the engaging groove 1002, so as to space the first side plate 102 and the second side plate 142 with the first distance D1, the second distance D2 or the third distance D3. The engaging structure 1402 comprises a resilient arm 1404 and two protruding portions 1406 and the two protruding portions 1406 are protruded from the resilient arm 1404. As shown in FIG. 4, when the first base plate 100 and the second base plate 140 slide with respect to each other to space the first side plate 102 and the second side plate 142 with the first distance D1, the two protruding portions 1406 are located inside the engaging groove 1002. As shown in FIG. 6, when the first base plate 100 and the second base plate 140 slide with respect to each other to space the first side plate 102 and the second side plate 142 with the second distance D2, the edge 1004 of the engaging groove 1002 is engaged between the two protruding portions 1406. As shown in FIG. 8, when the first base plate 100 and the second base plate 140 slide with respect to each other to space the first side plate 102 and the second side plate 142 with the third distance D3, the two protruding portions 1406 are located outside the engaging groove 1002. A side surface of each protruding portion 1406 may be formed as an oblique surface, such that the first base plate 100 and the second base plate 140 will push the oblique surface of the protruding portion 1406 during slide operation, and then the resilient arm 1404 will deform upwardly and elastically. Consequently, the slide operation will be smoother.

Moreover, the first base plate 100 has two restraining grooves 1006 and the second base plate 140 has two restraining portions 1408. The restraining portions 1408 are disposed in the restraining grooves 1006, so as to restrain the first base plate 100 from coming off the second base plate 140. As shown in FIG. 8, when the first base plate 100 and the second base plate 140 slide with respect to each other to space the first side plate 102 and the second side plate 142 with the third distance D3, the restraining portion 1408 abuts against one side of the restraining groove 1006, so as to restrain the first base plate 100 from coming off the second base plate 140 due to over-pull by the user.

In this embodiment, a plurality of first fixing holes 18 and a plurality of second fixing holes 20 are formed on the first side plate 102 and the second side plate 142, wherein the first fixing holes 18 are corresponding to a plurality of fixing holes (not shown) formed on opposite sides of a first storage device 30, and the second fixing holes 20 are corresponding to a plurality of fixing holes (not shown) formed on opposite sides of a second storage device 32.

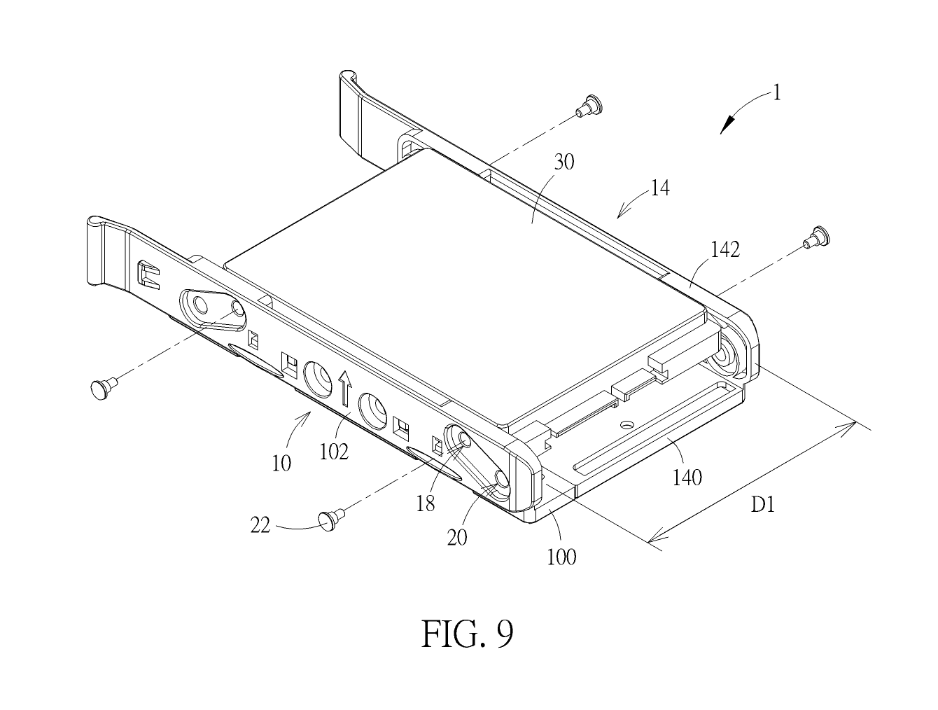

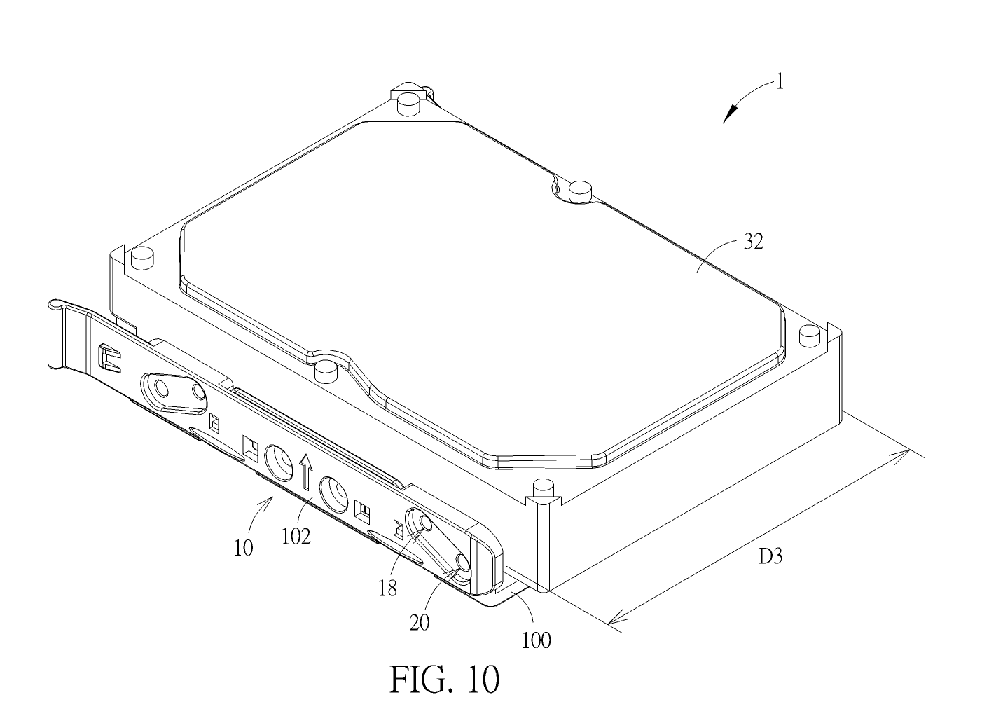

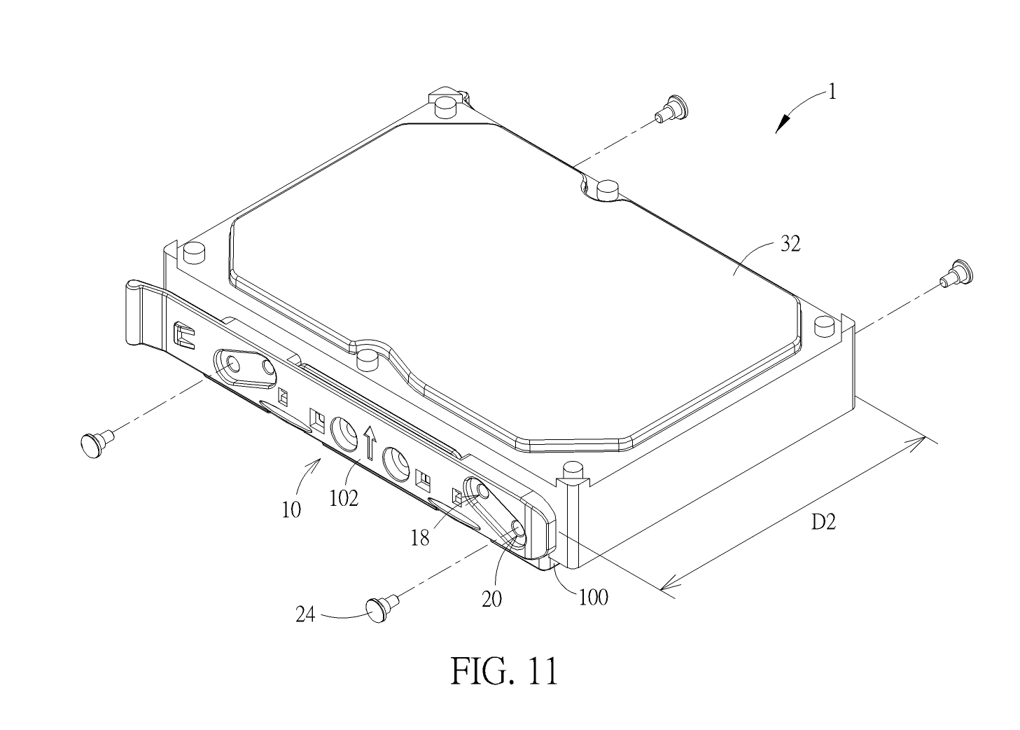

Referring to FIGS. 9 to 11, FIG. 9 is a schematic view illustrating a first storage device 30 carried by the storage device carrier 1 shown in FIG. 3, FIG. 10 is a schematic view illustrating a second storage device 32 carried by the storage device carrier 1 shown in FIG. 7, and FIG. 11 is a schematic view illustrating the second storage device 32 carried by the storage device carrier 1 shown in FIG. 5. As shown in FIGS. 9 to 11, the storage device carrier 1 of the invention can be used to carry the first storage device 30 and the second storage device 32 with different sizes. In this embodiment, the first distance D1 is substantially equal to a width of the first storage device 30, the second distance D2 is substantially equal to a width of the second storage device 32, and the third distance D3 is larger than the width of the first storage device 30 and the width of the second storage device 32. The first storage device 30 may be, but not limited to, a 2.5″ solid state drive (SSD), and the second storage device 32 may be, but not limited to, a 3.5″ hard disk drive (HDD).

When a user wants to use the storage device carrier 1 to carry the first storage device 30, he/she can operate the first base plate 100 and the second base plate 140 to slide with respect to each other to space the first side plate 102 and the second side plate 142 with the first distance D1, and then rotates the first support member 12 and the second support member 16 to expand the first support member 12 and the second support member 16 with respect to the first side plate 102 and the second side plate 142, as shown in FIG. 3. When the first side plate 102 and the second side plate 142 are spaced with the first distance D1, and the first support member 12 and the second support member 16 are expanded with respect to the first side plate 102 and the second side plate 142, respectively, the user can place the first storage device 30 on the first support member 12 and the second support member 16, such that the first storage device 30 is carried on the first support member 12 and the second support member 16 and sandwiched in between the first side plate 102 and the second side plate 142, as shown in FIG. 9. The storage device carrier 1 may further comprise a plurality of fixing members 22. The fixing members 22 may selectively pass through the first fixing holes 18 formed on the first side plate 102 and the second side plate 142, so as to fix the first storage device 30 between the first side plate 102 and the second side plate 142. In this embodiment, the fixing members 22 may be, but not limited to, screws.

When the user wants to use the storage device carrier 1 to carry the second storage device 32, he/she can operate the first base plate 100 and the second base plate 140 to slide with respect to each other to space the first side plate 102 and the second side plate 142 with the third distance D3, and then rotates the first support member 12 and the second support member 16 to fold the first support member 12 and the second support member 16 with respect to the first side plate 102 and the second side plate 142, as shown in FIG. 7. Since the third distance D3 is larger than the width of the second storage device 32, the user can place the second storage device 32 on the first base plate 100 and the second base plate 140 easily, as shown in FIG. 10. Afterward, the user can operate the first base plate 100 and the second base plate 140 to slide with respect to each other to space the first side plate 102 and the second side plate 142 with the second distance D2, such that the second storage device 32 is sandwiched in between the first side plate 102 and the second side plate 142, as shown in FIG. 11. The storage device carrier 1 may further comprise a plurality of fixing members 24. The fixing members 24 may selectively pass through the second fixing holes 20 formed on the first side plate 102 and the second side plate 142, so as to fix the second storage device 32 between the first side plate 102 and the second side plate 142. In this embodiment, the fixing members 24 may be, but not limited to, screws.

In another embodiment, the fixing members 24 may be disposed on the first side plate 102 and the second side plate 142 in the beginning. Since the third distance D3 is larger than the width of the second storage device 32, the fixing members 24 disposed on the first side plate 102 and the second side plate 142 will not interfere with the second storage device 32 while the user places the second storage device 32 on the first base plate 100 and the second base plate 140. Furthermore, since the first support member 12 and the second support member 16 are located above the fixing members 24 after being expanded with respect to the first side plate 102 and the second side plate 142, the fixing members 24 disposed on the first side plate 102 and the second side plate 142 will not interfere with the first storage device 30 while the user places the first storage device 30 on the first support member 12 and the second support member 16.

It should be noted that if the fixing holes formed on opposite sides of the first storage device 30 are identical to the fixing holes formed on opposite sides of the second storage device 32, the fixing members 22 maybe identical to the fixing members 24 correspondingly. If the fixing holes formed on opposite sides of the first storage device 30 are different from the fixing holes formed on opposite sides of the second storage device 32, the smaller fixing members of the fixing members 22 and 24 may be used to fix the first storage device 30 and the second storage device 32 at the same time.

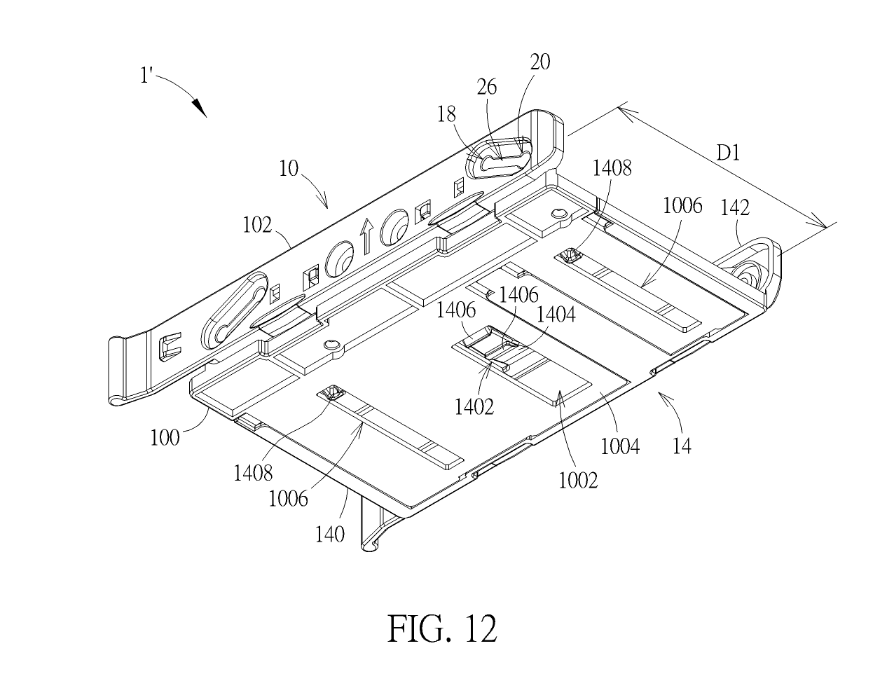

Referring to FIG. 12 along with FIG. 4, FIG. 12 is an assembly view illustrating a storage device carrier 1′ according to a second embodiment of the invention. The difference between the storage device carrier 1′ and the aforesaid storage device carrier 1 is that each of the first fixing holes 18 communicates with one of the second fixing holes 20 via a slot 26. Accordingly, the user can move a single fixing member between the first fixing hole 18 and the second fixing hole 20, so as to selectively fix the first storage device 30 or the second storage device 32.

As mentioned in the above, a user can operate the first base plate and the second base plate to slide with respect to each other, so as to adjust the distance between the first side plate and the second side plate. Furthermore, the user can rotate the first support member and the second support member, so as to expand or fold the first support member and the second support member with respect to the first side plate and the second side plate. Accordingly, the storage device carrier of the invention can be used to carry different storage devices with different sizes. In other words, the invention utilizes a single storage device carrier to carry different storage devices with different sizes. The operation of the invention is convenient and the use cost can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A storage device carrier comprising:
a first frame comprising a first base plate and a first side plate, the first side plate being extended from the first base plate;
a first support member pivotally connected to the first side plate;
a second frame comprising a second base plate and a second side plate, the second side plate being extended from the second base plate, the first base plate being slidably connected to the second base plate; and
a second support member pivotally connected to the second side plate, the first support member and the second support member being opposite to each other;
wherein the first base plate and the second base plate are capable of sliding with respect to each other, so as to space the first side plate and the second side plate with a first distance or a second distance; when the first side plate and the second side plate are spaced with the first distance, and the first support member and the second support member are expanded with respect to the first side plate and the second side plate, respectively, a first storage device is capable of being carried on the first support member and the second support member and sandwiched in between the first side plate and the second side plate; when the first side plate and the second side plate are spaced with the second distance, and the first support member and the second support member are folded with respect to the first side plate and the second side plate, respectively, a second storage device is capable of being carried on the first base plate and the second base plate and sandwiched in between the first side plate and the second side plate.

2. The storage device carrier of claim 1, wherein the first base plate has a plurality of sliding portions, the second base plate has a plurality of sliding grooves, and the sliding portions are disposed in the sliding grooves, such that the first base plate is slidably connected to the second base plate.

3. The storage device carrier of claim 1, wherein the first base plate and the second base plate are capable of sliding with respect to each other, so as to space the first side plate and the second side plate with a third distance, and the third distance is larger than a width of the first storage device and a width of the second storage device.

4. The storage device carrier of claim 3, wherein the first base plate has an engaging groove, the second base plate has an engaging structure, and when the first base plate and the second base plate slide with respect to each other, the engaging structure is selectively engaged with or disengaged from an edge of the engaging groove, so as to space the first side plate and the second side plate with the first distance, the second distance or the third distance.

5. The storage device carrier of claim 4, wherein the engaging structure comprises a resilient arm and two protruding portions and the two protruding portions are protruded from the resilient arm; when the first side plate and the second side plate are spaced with the first distance, the two protruding portions are located inside the engaging groove; when the first side plate and the second side plate are spaced with the second distance, the edge of the engaging groove is engaged between the two protruding portions; when the first side plate and the second side plate are spaced with the third distance, the two protruding portions are located outside the engaging groove.

6. The storage device carrier of claim 1, wherein the first base plate has a restraining groove, the second base plate has a restraining portion, and the restraining portion is disposed in the restraining groove, so as to restrain the first base plate from coming off the second base plate.

7. The storage device carrier of claim 1, wherein a plurality of first fixing holes and a plurality of second fixing holes are formed on the first side plate and the second side plate, the storage device carrier further comprises a plurality of fixing members, and the fixing members selectively pass through the first fixing holes or the second fixing holes, so as to fix the first storage device or the second storage device between the first side plate and the second side plate.

8. The storage device carrier of claim 7, wherein each of the first fixing holes communicates with one of the second fixing holes via a slot.
